(19) United States
(12) Patent Application Publication
(10) Pub. No.: US 2010/0223804 A1
(43) Pub. Date: Sep. 9, 2010

(54) Air modulating non-thermal dryer

(76) Inventors: John R. Flaherty, Las Vegas, NV (US); Randolph D. Hedgebeth, Tacoma, WA (US)

Correspondence Address: Svendsen Legal, LLC, P.O. Box 10627, Yakima, WA, 98909, US

(21) Appl. No.: 12/660,520

(22) Filed: Feb. 25, 2010

Related U.S. Application Data
(60) Provisional application No. 61/208,759, filed on Feb. 27, 2009.

(51) Int. Cl. F26B 3/36; F26B 25/06

(52) U.S. Cl. 34/279; 34/218

(57) ABSTRACT

An air modulating non-thermal dryer (AMND) system that de-waters a wet feedstock stream with an ambient airstream, to produce a dried product stream. The system utilizes a drying chamber in the efficient production of a dried product, and includes an acoustic induced air motion liberation or “SONICATION™” of the moisture with a combination of drivers, labyrinth transmission lines, and air modulating devices. Initially, a 50% to 60% dry composite of biomass or biosolids is pneumatically conveyed to the chamber through an in-line cutter and a swiveling load leveler with an atomizing nozzle for final shredding. The system can liberate up to 90% of the moisture content, using high volumes of process air, along with infeed motive air to deliver wet feedstock material into the chamber. Expelled airborne moisture may be discharged to atmosphere, without further processing, or it may be recaptured for potable uses.

### TECHNICAL FIELD

The invention relates to a forced air, non-thermal drying system. More particularly, the invention relates to an air contact dryer that modulates the flow of air through an industrial scaled cross-sectional moisture exchanger with the aid of low frequency vibrational waves, to desiccate and de-agglomerate a wet particulate matter, without requiring the use of heat.

### BACKGROUND OF THE INVENTION

Many industries generate sludges and water-heavy streams, most of which are difficult to de-water or desicate for cost-effective re-cycling, or for efficient and economical utilization in forming process by-products. Environmental and marketplace constraints have converged to create a demand for a workable and economially viable, industrial scaled drying system. Especially with the added pressure of fuel and electricity costs, a system for an in-flow drying system with a control package is needed to effectively and economically dry and “up-cycle” sludges, or other wet process streams. The present invention addresses these operational needs and provides a new system of drying wet material streams on an industrial scale. The aspects and advantages of the invention will become apparent from consideration of the following figures and description.

### BRIEF DESCRIPTION OF DRAWINGS

FIG. 1 is a perspective view of an air modulating non-thermal dryer system, according to an embodiment of the invention;

FIG. 2 is a partially hidden line perspective view of an air modulating non-thermal dryer system, according to an embodiment of the invention;

FIG. 3 is a partially hidden line view of the dying chamber portion of air modulating non-thermal dryer system, according to an embodiment of the invention;

FIG. 4 is a schematic diagram of the upper phase of an air modulating non-thermal dryer system, according to an embodiment of the invention; and

FIG. 5 is a schematic diagram of the upper phase of an air modulating non-thermal dryer system, according to an embodiment of the invention.

### DETAILED DESCRIPTION OF SPECIFIC EMBODIMENTS

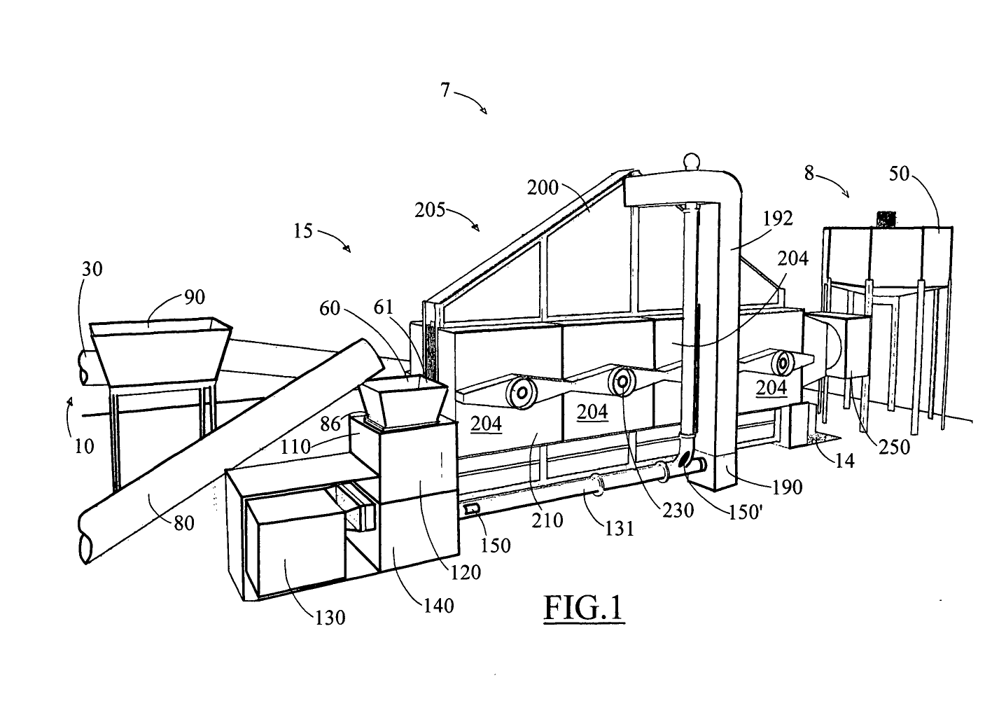

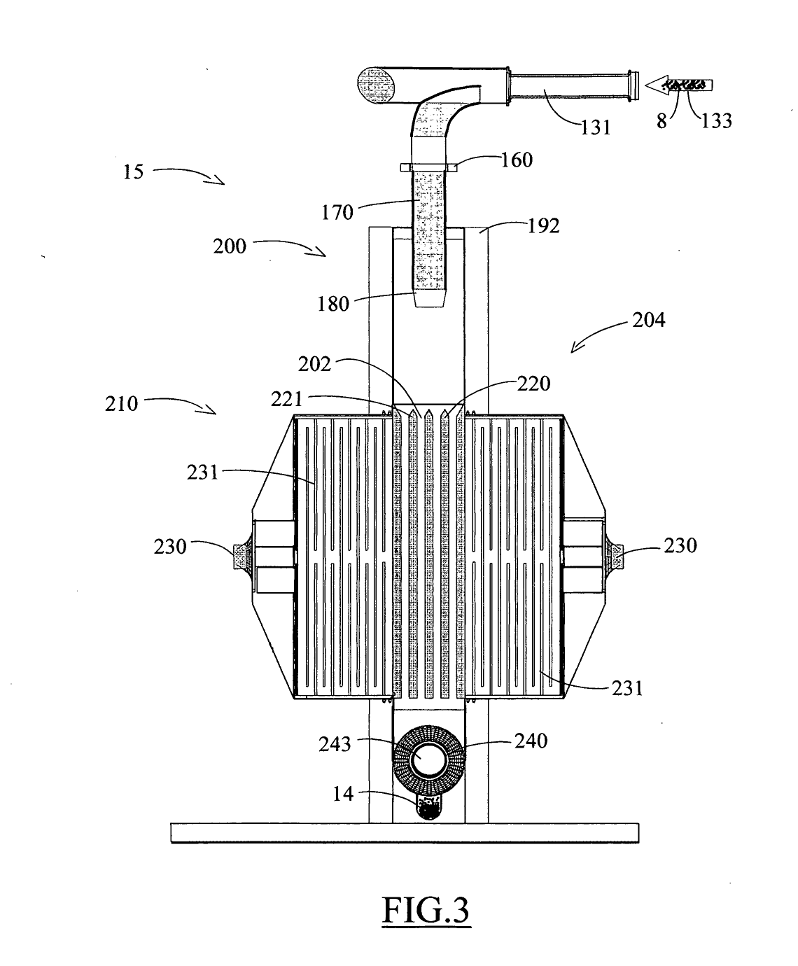

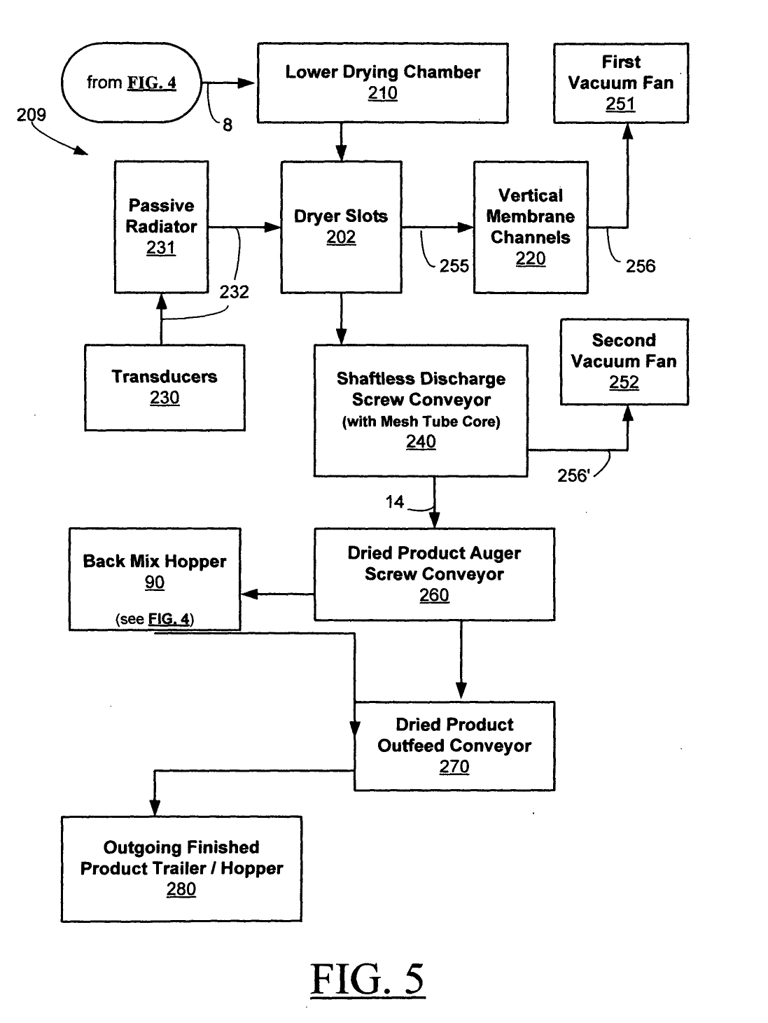

The present invention for an air modulating non-thermal dryer (AMND) system that de-waters a wet feedstock stream with an ambient airstream, to produce a dried product stream. The AMND system may also be described as a direct/indirect, and push/pull moisture separation system. A preferred embodiment of the AMND system 7 of the present invention, is shown in FIGS. 1 through 5. As detailed in FIG. 3, a central feature of the AMND system is a drying chamber 15 that includes an upper drying chamber 200 and a lower drying chamber 210, as described herein, and utilized in the efficient production of a dried product 14.

### A0. Upstream Phase

The introduction the feedstock 8 to the upper drying chamber 200, begins an “upstream phase” 9 of the AMND system 7. The AMND system 7 receives a feedstock 8 for processing, by way of an incoming feedstock delivery 10, which may be a trailer, screw, conveyor, or any mechanism to convey the incoming wet material to the AMND.

Preferred feedstocks 8 substantially include biosolids and biomass. “Biosolids” are generally defined as municipal waste water treatment plant, or paper mill residuals, and herein referred to as a sludge 41. A “biomass” 42 is herein defined as any type of wet wood, typically received as approximately thirty to fifty percent solids, by weight.

Biosolids or sludges for the feedstocks 8 are typically received at approximately eighteen to thirty percent polymerized solids, by weight. The feedstock delivery 10 may be any pneumatic conveyance, conveyor screw, conveyor belt, or truck. Preferably, any received feedstocks need to be dried to approximately eighty-five percent solids, by weight, for optimal processing by the AMND system 7. The term “approximately” is used herein, to refer to a range of values or relative orientations, understood by a person skilled in the pertinent field or vocation, as being equivalent to the herein stated values in achieving the desired results, a range typical to the accuracy and precision of conventional tooling or techniques, or a functionally equivalent range of features that produces equivalent results to those described herein. Additionally, the term “substantially” is used herein to refer to a range or quality that is dominantly or mostly, but may not be wholly that which is specified.

### A1. Incoming Wet Material Feedstocks

The feedstock 8 may also be a peat moss, a wood waste such as a hogged fuel or sawdust, an animal waste including a dairy, hog or chicken manure, “bagasse” including sugar cane, “agave” or tequila plants, empty fruit baskets, food waste, paper pulp sludge, spent malts and dried distiller grain.

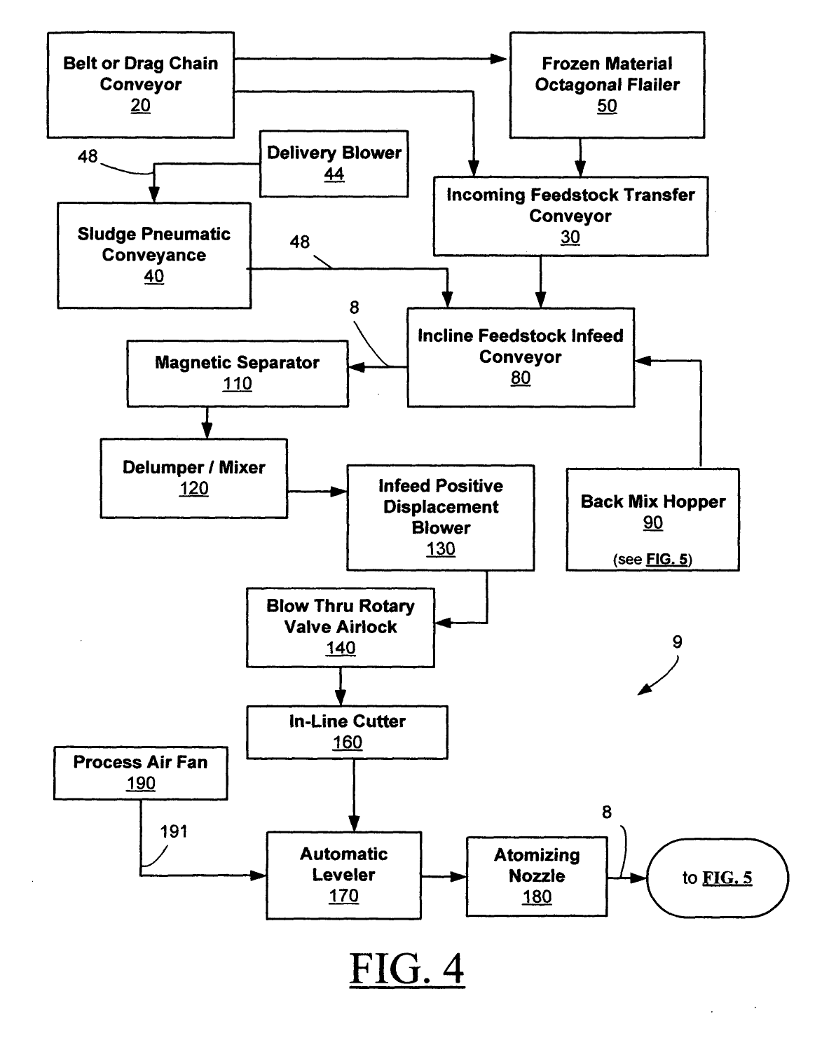

In a preferred embodiment, the feedstock delivery 10 into the AMND system 7, may be an approximately forty-five foot long, walking floor trailer that can be backed into the processing site with the AMND system, to deliver approximately twenty-five tons of the wet feedstock material. The feedstock material will typically range under fifty percent solids, in water, by weight. As shown schematically in FIG. 4, the feedstock 8 is discharged into a truck unloading drag chain conveyor 20, preferably at the rate of approximately ten tons per hour. At that rate, the detention time for the trailer should be approximately two and one half hours. The empty trailer then pulls away and returns with a new twenty-five ton load. Most preferably, a separate, hydraulic power unit provides the unloading capability for the walking floor trailer discharge conveyor. As an alternative, the wet feedstock can also be introduced by a pneumatic conveyance delivery system 40, which may be a screw feeder or conveyor belt, based on site specific needs for a particular application. Preferably, the pneumatic conveyance delivery system includes a pneumatic conveyance pipe to route the feedstock into a target box 60.

### A2. Truck Unloading Drag Chain Conveyor

The truck unloading drag chain conveyor 20, which includes a hopper, preferably receives the wet wood at the rate of approximately ten tons per hour, and drops the material into an incoming feedstock transfer conveyor 30.

Preferably, the AMND system 7 is designed with three tons of“surge capacity.” The walking floor of the incoming material conveyor 10 meters a wall of material into the hopper of the drag chain conveyer 20, and the drag chain flights drags the material up its incline and into the incoming feedstock transfer conveyor 30. Most preferably, a separate, hydraulic motor powers the drag chain conveyor. This receiving strategy is used primarily employed for wet wood or other materials having at least fifty percent solids by weight, which do not need to be “back-mixed” or recirculated.

### A3. Incoming Feedstock Transfer Conveyor

Optionally, the feedstock delivery 10 can include an incline screw to transfer the feedstock 8 into a third inlet of a feedstock infeed mixing conveyor. This seven and one-half HP infeed mixing conveyor can be a standard transfer conveyor, as manufactured by Austin Mac, or an equivalent. The feedstock infeed mixing conveyor preferably has a back wall slope sheet to prevent spillage and discharge, and serves to further meter the flow rate of biomass into mixing screw. Preferably, this screw has an approximately twenty-five degree incline over its twenty foot length, with a twelve inch diameter.

### A4. Sludge Pneumatic Conveyance Delivery

Alternatively, the feedstock delivery 10 may be an incline screw conveyor that drops the feedstock 8 into a surge hopper. The feedstock from a de-watering belt presses or a centrifuge is a sludge 41. The dewatering apparatus is preferably housed within a de-watering building or similar functioning enclosure. The sludge can be deposited into the pneumatic conveyance delivery 40 at a production rate of approximately six wet tons per hour, defined as a polymerized 20% solid cake, by weight. The sludge can fall out of the surge hopper into a chute of an infeed airlock, which is a conventional rotary valve airlock. A delivery “positive displacement blower,” or delivery blower 44, provides a stream of conveyance air, to propel the sludge through an approximately eight inch diameter conveyance pipe and into a diverter, which is preferably a standard, electrically actuated material stream diverter, also approximately eight inches in diameter. This diverter has the option of sending the cake into the drying building, or alternatively into a large capacity dump truck, if the AMND system 7 cannot immediately accept the cake.

The pneumatic conveyance pipe of the pneumatic conveyance delivery 40 is preferably insulated outside of the de-watering building and then runs along the interior wall of the drying facility. A preferred detention time within the pipe is approximately four seconds, at an expected temperature rise from the six inches in water column pressurization by the PD delivery blower 44, shown schematically in FIG. 4, to seventy degrees F., above ambient. Approximately two thousand acfm is a preferred flow rate of a delivery motive air 48, supplied from the PD delivery blower system, as preferably manufactured by Hank Baum Pneumatics.

### A5. Frozen Material Octagonal Flailer & Conveyance

In the event the AMND system 7 is processing frozen biomass as the feedstock 8, a specially fabricated octagonally shaped “flailer” 50 can be utilized to break up the frozen sections into one inch “minus” material. As shown in FIG. 1, this eight sided, horizontal flailer apparatus can be powered by an approximately fifty HP motor, centrally mounted above the chamber of the flailer. The output motor shaft can be splined to a hub with eight attachment holes to fasten the eight chain link sections. The chamber is preferably configured at eight feet in diameter, with the chain sections three feet long each, with the internal chains fastened by eight devises to the hub within the chamber.

Chain tip twirling speed within the flailer 50 may reach four-hundred mph, with applicable heat gained by the feedstock 8 from the friction. Some melting may also occur, as the feedstock material falls down, onto vibrating round screen of approximately six feet in diameter. The domed vibrating chamber is most preferably insulated and heat traced. More melting will occur for moisture to drain through screen and solids scalped off the top deck of the screen discharge slot. The round vibrating deck separator can be manufactured by Sweco Manufacturing, with a two HP motor for the vibrator.

If the feedstock 8 are biosolids or alternatively sludges 41 and are conveyed outdoors, there may be freezing within the pneumatic conveyance delivery system 40. If so, it will occur very gradually, and a standard operating procedure to avoid full line freezing is to simply monitor the increase the free running pressure, as is a standard method in process monitoring and control.

The pneumatic conveyance delivery system 40 will probably start up with an initial pressure drop of approximately two psi through the pneumatic conveyance pipe, and then in later operation the pressure may rise to approximately two and a half to three psig, which may indicate a gradual build up inside the pipe, especially likely during extreme weather conditions. Therefore, it is suggested to require a clean-out of caked-on residues or “pigging” of the pneumatic conveyance delivery line on a regular maintenance schedule. At higher velocities of conveyance pipe designs, it is not expected that the pipe will freeze. However, to effectively address this potential issue, the delivery system operator will need to watch the conveyance pipe daily, and determine if there are any issues and then provide any maintenance or corrective action, as required.

The free running pressure within the pneumatic conveyance delivery pipe 47 will typically rise initially after commissioning, when initial, small air leaks plug with material, especially during the first hours of operation, then it will “polish” the first day dropping free running pressure estimated at approximately one-eighth psig, and then likely polish another approximate one-eighth psig over the following month or so, of operation. Compared to other typical pneumatic systems known in the industry, this is an easy pressure to monitor, and should work well over time, due to the short travel distance. Additionally, since the majority of the line is located preferably inside the de-watering building or enclosure, the conveyance delivery pipe should be adequately insulated.

### A6. Target Box

The target box 60 is preferably fabricated to accept the pneumatic conveyance pipe 45, which preferably carries six tons of wet cake sludge 41, each hour. Most preferably, the cake collides with a sixty degree forward angled slope sheet 61, to deflect material downward into a target chute 62, located above a shaftless screw surge hopper. The target box slows down particle velocity and is preferably situated approximately twelve feet above the target chute, between the upper drying chamber 200 and a back mix storage hopper 90.

### A7. Sludge Shaftless Screw Conveyor

Preferably, a shaftless screw conveyor receives the wet cake sludge 41 from the pneumatic conveyance delivery system 40 at the approximate rate of six tons per hour, in a preferred embodiment of the AMND system 7. The shaftless screw is designed to motivate sticky materials, and to deposit the sludge, with approximately twenty percent solids by weight, into a first inlet of an initial inlet of the feedstock infeed mixing conveyor. The cake drops down from the target box 60, above, into an infeed surge hopper 86, which has the preferred capacity of approximately five hundred and fifty pounds. Preferably, the shaftless screw conveyor has a footprint of fourteen feet long by three feet wide, and is twelve inches in diameter, with a six and twelve inch pitch. Austin Mac is again a preferred manufacturer of the screw conveyor.

### A8. Feedstock Infeed Mixing Conveyor

The feedstock infeed mixing conveyor 80, also preferably manufactured by Austin Mac, powered by an approximately fifteen HP motor, and most preferably includes three inlets. The first inlet 81 of the feedstock infeed mixing conveyor feeds the sludge 41 materials, such as biosolids. The second inlet 82 infeed supplies a dry backmix 91, from a backmix storage hopper 90, which is a preferred process step when running sludge. Additionally, the third inlet 83, is for the infeed of biomass 42. A “wet cake” of the sludge is introduced first, through the first inlet, then the previously dried backmix is added through the second inlet. Mixing by the feedstock infeed mixing conveyor is preferably accomplished by a conventional, variable speed ribbon-paddle mixing screw 85. The conveyor is preferably oriented at a fifteen-degree incline with an eighteen-inch diameter, a twelve inch pitch, and a twenty foot long screw. Generally, a “wet wood” biomass will not require backmixing in the AMND system 7, so in that instance, the feedstock 8 material from the incoming feedstock transfer conveyor is augured directly into a magnetic separator 110.

### A9. Backmix Hopper and Live Bottom Twin Screws

The purpose of the backmix hopper 90 is to store dried product 14, referred to herein as the dry backmix 91, for mixing this finished and dried material with incoming wet cake sludge 41. A preferred capacity of the hopper is approximately seven hundred and thirty cubic feet, which is approximately ten tons at the standard conversion of thirty pounds per cubic foot. The tapered dimensions of the bin are fourteen feet long and nine feet high.

Preferably configured in the “belly” of the bin of the backmix hopper 90 are twin tapered bottom screws, each preferably powered by a five HP motor, with variable speed controls, as discussed herein. These horizontal, tapered auger screws are preferably eighteen inches in diameter, with eight inch and eighteen inch pitches, and is approximately eighteen feet long. The backmix hopper also serves as surge capacity for the take-away, dried product 14, which is especially useful while outgoing trailers are being exchanged. The design feed rate of dry backmix 91 is approximately one to two dry tons per hour, with a total back mix capacity of approximately eight tons per hour of the mixed and discharged dried, finished product.

### A10. Incline Feedstock Screw Conveyor

The material of the dry backmix 91 is then metered into the ribbon-paddle mixing screw, of the feedstock infeed mixing conveyor 80, located beneath the discharge chute of the backmix hopper 90. The ribbon-paddle mixing screw is preferably a fifteen HP motor driven incline screw conveyor as preferably provided by Austin Mac, to deliver the feedstocks 8 at a rate of approximately ten tons per hour into a “delumper” 120, which is located above a “blow through” rotary valve airlock 140. In a preferred embodiment, further mixing is achieved by the preferred ribbon-paddle configuration of the conveyor's mixing screw. This screw is most preferably set at an approximate thirty degree incline, with an eighteen-inch diameter and a twelve inch pitch along its preferred, eighteen foot length.

### A11. Magnetic Separator

A magnetic separator 110 is preferably utilized for metal removal from the feedstock 8, and is preferably fabricated by Eriez Magnetics. The magnetic separator has no moving parts and includes deeply reaching extreme powered magnets maintained at an eight inch gap between both sides of the magnet. A preferred length of the magnetic separator is eighteen inches with a designed throughput capacity of twenty tons per hour. The magnetic separator also includes access doors that swing open on both sides of the device, for cleaning and removal of “tramp metal,” which may be nuts, bolts, screws, washers, and any other ferrous metallic materials. The low profiled magnetic separator is situated above the inlet of the delumper 120 and underneath the incline feedstock infeed mixing conveyor 80.

### A12. Feedstock Delumper

The delumper 120 for the feedstock 8 is preferably a ten HP motor equipped mixer and shredder situated on top of a rotary valve airlock 140 and connected to the rotary valve airlock with a delumper outlet chute 121. The delumper is preferably a standard “knife” type mixer and delumper serves to cut and finish mix the composite of wet sludge cake and previously dried sludge. Franklin Miller is a preferred manufacturer of the delumper, which is rated to process twenty tons per hour, of a typical material density of forty pounds per cubic foot. The delumper is essentially a cutter and mixer that renders the incoming feedstock more “friable,” or better able to break apart.

### A13. Infeed Positive Displacement Blower (PD Blower)

A positive displacement or “PD” type of Roots brand blower, is preferably employed as an infeed blower 130, for pneumatic conveyance, and can be provided by Hank Baum Pneumatics to rout the mixed and prepared feedstock 8 to the drying chamber 15 of the AMND system 7. The preferred blower is preferably powered by an approximately one hundred and twenty-five HP motor manufactured by Baldor is preferably utilized for the blower.

The primary purpose of the infeed blower 130 is to pick up the feedstock 8 material to be processed by the drying chamber 15, delivering it from underneath the discharge of the rotary valve airlock 140, and propelling the material down-stream through an infeed conveyance line 131. The infeed conveyance line, has a preferred diameter of approximately eight inches and routs the feedstock through an in-line cutter 160 and into a load leveler 170. The infeed blower preferably propels an infeed motive air 133, at approximately two thousand cfm and a design static pressure of six inches of water column. As designed, the initial pick up velocity by the infeed blower, is essentially zero, and within the first fifteen linear feet the travel velocity achieves five thousand feet per minute. This dilute phase pneumatic conveyance also provides a frictional heat gain of approximately ten degrees F., per psi. Therefore, if the ambient temperature is seventy degrees F., and the target operating pressure is six psig, the temperature of the infeed motive air, at discharge into the upper drying chamber 200, will be approximately one hundred and thirty degrees F.

Optimally, the infeed blower 130 transports pre-processed feedstock 8 material that is approximately fifty percent solids, by weight in water. Any bends in the eight inch diameter infeed conveyance line 131 should be sweeping ninety degree angles. Additionally, inlet and outlet silencers installed on the infeed conveyance line are considered necessary to keep sound levels under approximately eighty-six decibels.

### A14. Blow Through Rotary Valve Airlock

The rotary valve airlock 140 located immediately downstream and preferably beneath the delumper 120 is preferably manufactured by Hank Baum pneumatics, in addition to the infeed blower. The airlock is most preferably a “blow-through” type, with an eight vane, airlock and driven by a seven and one-half HP motor, to meter and deposit the wet feedstock 8 material into the eight inch diameter pneumatic infeed conveyance line 131. The airlock, or injector, has a delivery chute 144, above the body of the airlock. The feedstock material should be friable and free flowing through the airlock, and the rotor preferably turns at approximately forty-five rpm. A blade knife 145, positioned just above the rotating vanes 146 helps keep the leading edge of the vanes clean and helps prevent any carry back of material. The preferred selection of the conventional blow-through design of the airlock helps purge the vanes as the feedstock material is deposited into the infeed motive air 133 of the infeed conveyance line 131.

### A15. Conveyance Line Clean-Outs

The infeed conveyance line 131 preferably includes a clean-out 150, and most preferably two clean-outs. The conveyance line clean outs are standard access and clean-out panels, flanged to the eight inch conveyance line. A first clean-out 151 may be positioned directly in front of the discharge of the rotary valve airlock 140. The second clean out 152 is preferably located in front of a ninety-degree sweeping elbow heading into the upper drying chamber 200. Optimally, both clean-outs are located at ground level and have quick disconnect couplings. The purpose for these clean-outs is to facilitate inspection and preform any clean out operations needed for the conveyance line, in the event of line plugging.

### A16. In-line Cutter

The preferably employed in-line cutter 160 is most preferably sized at twelve inches in diameter, and can be manufactured by Franklin Miller. This preferred in-line cutter is also referred to as the brand name Super-Shredder' Model 1200, of in-line disintegrator. The in-line cutter can operate at a relatively low speed, with its high torque cutter and grinder serves to increase the efficiency of the drying process immediately downstream, by reducing particle sizes and exposing more particulate surface area. The preferred “Model 1200” has a twelve inch diameter inlet to easily accommodate the eight inch diameter infeed conveyance line 131, and providing a significant drop in the flow velocity of the incoming feedstock 8. Additionally, the bi-directional action cutter, preferably equipped with an approximately ten HP motor, is preferably constructed out of corrosion resistant “T316” type stainless steel, with a conventional heavy fused-coating applied to the cutting surfaces.

### A17. Load Leveler

Optionally, primarily depending on the material transfer properties of the incoming feedstock 8, an automatic load leveler 170 can be employed at the inlet to the upper drying chamber 200, to facilitate injection of the feedstock. Hank Baum is a preferred manufacturer of the load leveler, as marketed under the brand name of WIG-WAG'. This device, as powered by an approximately five HP motor, is derived from a loading apparatus used for pneumatically delivering material into open top railroad cars, evenly and with a level distribution. The automatic load leveler employs an atomizing nozzle 180, which is affixed to an articulated duct 175, to inject the material into the upper drying chamber.

The AMND system 7 preferably utilizes the articulating duct 175 of the automatic load leveler 170 to deliver the process air 191, and the infeed motive air 133 with the feedstock 8 to be dried, into the upper drying chamber 200. The feedstock material can be discharged through the atomizing nozzle 180, and swing in a pendulum motion on a ninety-degree arc. This load leveler can incorporate a conventional ninety degree “smart elbow,” as is preferably housed in the insulated triangular structure of the upper drying chamber. Some “fugitive” wet process air may be discharged from the apex of the housing of the upper drying chamber.

### A18. Atomizing Nozzle

For initial, precursor designs, the atomizing nozzles 180 had only a four-inch diameter outlet. This was found to be unsatisfactory in pilot tests and a re-designed eight inch nozzle is now preferred for use with the AMND system 7, to deliver up to twenty tons per hour of feedstock 8 materials into the upper drying chamber 200. The preferred stainless steel atomizing nozzle serves as an atomizing and also a static-shredding device. There are no moving parts in the nozzle. The desired “shot pattern” for the nozzle is a sixty-degree full cone. The nozzle's broadcast is spread out evenly by the action of the load leveler 170. The broadcasted materials will land directly and evenly on targeted gaps or channels 201 inside the triangular shaped upper drying chamber, which is approximately two feet in width. The incoming feedstock material should not be any larger than one-half inch in diameter, in order to assure the needed further reduction in particle size, and to prevent plugging.

The atomizing nozzles 180 are located at the discharge of the eight inch diameter infeed conveyance line 131. The nozzles must be monitored for regular replacement, once a wear pattern and service life are established. Preferably, the nozzles can be screwed or welded onto the conveyance line's discharge end, which may be tapered to increase velocity. An objective for the nozzle's discharge is not to impinge on the walls of the upper drying chamber. This delivery approach allows for maximum dwell time of the feedstock 8 within the upper drying chamber 200, and co-mingling of the solids with the process air 191 and infeed motive air 133. Preferably, the walls of the upper drying chamber are coated with a typical non-stick type of coating or panel material, as are well known in the industry.

### A19. Process Air Fan

Preferably, the process air fan 190 is provided by Twin Cities or Aerovent Fan Co., and should be factory balanced and balanced on site, prior to commissioning. The process air fan is sized at twenty HP at ten inches wg of static pressure, to provide the approximate thirty thousand cfm, to carry off the separated moisture 211 from the airborne feedstock 8 solids. The process air fan is designed for this specialized “push and pull” application, with a positive ten inches of water column gage, or “wg.” The process air fan is preferably belt and pulley driven. The needed thirty thousand acfm of process air is delivered into the triangular shaped upper drying chamber. Heat gain within the fan adds approximately five degrees F., and the temperature at discharge is approximately seventy-five degrees F.

The delivery of the process air 191 is to allow the surface and bound water molecules to leave the solids of the feedstock 8 and “report” or migrate to the process air. Some of the moisture saturated air will be drawn through the vertical drainage channel membranes 220, while the remaining air can exhaust upward and out the apex of the triangular insulated structure of the upper drying chamber 200. An “Aerovent” process air fan 190 is most preferred, which is classified as a centrifugal axial or “centaxial” fan. The fan should be mounted on vibration isolators or dampeners. Accordion expansion coupling should be mounted between discharge fan gasket and inlet duct work. The fan should be carefully mounted on support frame or concrete without any twisting or torque in the structural support. As an additional note, the free moisture removed from upper drying chamber alleviates the water removal load from the lower drying chamber 210, downstream.

### A20. Upper Drying Chamber

Preferably, the upper drying chamber 200 is insulated to reduce heat loss and attenuate sound, and is approximately twenty-four feet in length, two feet wide and twenty-five feet tall. The process air 191 is delivered through a process air duct 192 that discharges into the triangular upper drying chamber containing the load leveler 170. The process air further mixes with the airborne solids of the feedstock 8, being delivered with the infeed motive air 133. Most of any free surface moisture 201 that “reports” or evolves at this combination of motive air at two-thousand cfm, and process air at thirty-thousand cfm can vent through the apex of the triangular structure. The airborne solids are evenly distributed upon the channel openings of dryer slots 202, allowing the damp materials to drop down between the approximate two-inch gaps of the dryer slots.

### B0. Downstream Phase

With the drying chamber 15, the AMND system 7 processes the feedstock 8 in a “downstream phase” 209. The feedstock material is first blown onto the dryer-slots 202, which are open at the top of the insulated, upper drying chamber 200, and then the material migrates into the lower drying chamber 210, below. Most preferably, four drying chamber “modules” 204 are situated end-to-end to form a “unit” 205, totaling approximately twenty-four feet in overall length, and each unit served with approximately thirty thousand cfm of process air 255, along with approximately twenty tons per hour of feedstock material. The design throughput capacity of the system can vary with the incoming moisture content and specific drying characteristics of a particular material.

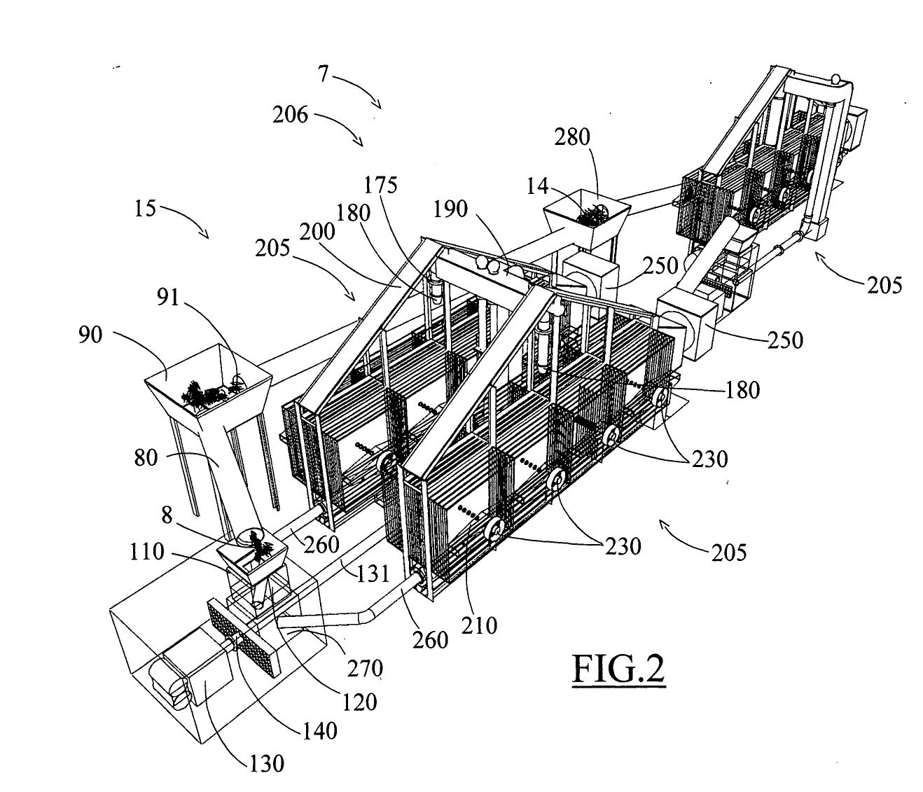

As preferred, three units 205 can be linked together, as shown in FIG. 2, to form a “triad” 206, with the first two units processing in parallel, to serve as pre-conditioners of the feedstock to the third unit. As preferred, a portion of the dried product 14 from the third unit in the triad, to be recycled back to the initial two units by way of the back-mix hopper 90, as described above.

The evolved moisture 221 is separated from the feedstock 8 solids, and “reports” or is expelled through a multiple of drainage channel membranes 220, which hang vertically within the lower drying chamber, separated by the dryer-slots 202. A pair of vacuum fans 250, specifically a first vacuum fan 251 and a second vacuum fan 252, together exhaust the process airstream 255 under suction or negative pressure, to aid in the drawing of moisture by capillary or “wicking” action, from the feedstock.

For the AMND system 7, the moisture 221 is liberated from the feedstock 8 by virtue of the “push and pull” or supply and suction environment, within the drying chamber 15. This moisture liberation is significantly augmented by air modulations created through sub-sonic vibrations, which shake loose free-surface, inter-cellular, and bound moisture from the feedstocks 8. This “acoustical” approach utilizes an air modulation transducer 230 system, which preferably includes a multiple of transducer and driver assemblies 231, all preferably selected to withstand the rigors of a year-around duty cycle.

With the aid of the acoustic de-watering, or SONICATION', as utilized in the AMND system 7, the moisture 221 from the feedstock 8 is expelled to the process air stream 255, which is preferably discharged into the atmosphere as a moisture rich, discharge airstream 256. Alternatively, the expelled moisture may be precipitated and captured for potable uses.

With the AMND system 7 the wet feedstock 8 is converted to the dried product 14. The removal of the moisture 221 from the feedstock is accomplished without further, thermal processing. Additionally, the de-watering is essentially an evaporative process, without combustive heat added to the drying chamber 15, other than the frictional heat generated by forced air movements. Therefore, zero “combustion emissions,” typically designated as SOx, NOx, COx, and VOC's, are discharged from the system, which alleviates environmental and siting concerns, along with the arduous task of securing such permits.

The dried solids 14 drop on top of a discharge screw 240, which is preferably a “shaftless” auger, running the length of the unit 205, which is approximately twenty-four feet and having an eighteen-inch diameter. This screw has a twelve inch diameter mesh tube 243 within the core of the screw that allows for an additional vacuum to be pulled by the second vacuum fan 252, while conveying the material onto the dried product auger screw conveyor. The finished dried product will continue into the backmix hopper 90, and into the finished product outfeed conveyor 270. Approximately forty gallons of water per minute can be entrained in the saturated, moisture 221 laden discharge airstream 256. Additionally, several alternative uses of wet, discharge air are available, such as greenhouse ventilation.

### B1. Lower Drying Chamber

The downstream phase 209 of the AMND system 7 begins at the lower drying chamber 210. Like the upper drying chamber 200, the lower drying chamber is preferably also insulated for lower sound transmission and heat-loss, and may be comprised of four modules 204, each six feet long by two feet in width and six feet high. Hence, the preferred overall length of the rectangular lower drying chamber is twenty-four feet, with the module portions placed end-to-end, and is situated directly beneath the triangular shaped upper drying chamber, having the approximate length.

A transducer 230 is mounted on each side of each of the four modules of the lower drying chamber 210, and each drive an air modulation within the lower drying chamber. Sub-sonic vibrational forces generated by the transducers shake the solids of the feedstock 8, to liberate moisture 221 from the feedstock.

The drainage channel membranes 220 is composed of a mesh material having a mesh size of fifty standard mesh size, in sheets of approximate six feet by six feet, which hang down vertically and sandwiches the material between two inch drainage channels or dryer-slots 202. Every other channel or “gap” pulls a vacuum as the air is drawn horizontally to provide a capillary and “wicking” action through the membrane material. A throughput of ten tons per hour moisture 221 is drawn through the membrane material and is discharged through the vacuum fans 250.

The twenty-four foot long, eighteen inch diameter shaftless discharge screw 240, as preferably manufactured by Austin Mac, delivers the dried product to the dried product auger 260. The shaftless auger contains a twelve inch mesh core that allows the suction air from the second vacuum fan 252, to pull the final moisture 221 out of the screw conveyed product.

### B2. Vertical Hanging Channel Membranes

As discussed above, relating to a preferred embodiment of the AMND system 7, air modulation transducers 230 are mounted on both sides of each module 204 in the lower drying chamber 210. The transducers create sub-sonic vibrations that serve to drive the moisture 221 out of the feedstock 8 solids. The expelled moisture can then be pulled through the size fifty standard mesh, or three hundred micron openings, by action of the vacuum fans 250. The channels are spaced approximately two inches apart, with alternating gaps filled with material and the other gaps pulling a horizontal vacuum. These hanging membranes may be electrically grounded, and are mounted to remain taut. A preferred membrane mesh material composition is a copper or alternatively a stainless steel. However, Basalt, Monel, and polyester are also considered ad alternative materials for use as channel membranes, depending on wear, cost and charge characteristic requirements.

### B3. Air Modulation

Feedstock 8 material drops from the triangular shaped upper drying chamber 200, into the lower drying chamber 210. Most preferably, the air modulation transducers 230 are moving coil or moving “magnet drivers,” sized to handle approximately twenty kW, and each able to generate a low frequency air pressure wave 232 that are substantially sub-sonic, as low as five to twenty Hz, from an approximately eighteen inch “woofer,” directed through a system of “labyrinth transmission lines” 231, and thereby driving a passive radiator, which serves to efficiently generate complex subsonic air modulation frequencies. This vibrating energy breaks down bonds of material being processed between the falling material and the air slots of the lower chamber. Preferred air modulation transducers are the AudioPulse' LMS-Ultra 18-inch model, ultra high energy subwoofer driver, as manufactured by TC Sounds of San Diego, Calif. The preferred sound modulation system allows for the capillary action for the adhesion of the moisture 221 to the process air. The substantially sub-sonic, low frequency vibrations also help keep the meshed membranes from blinding. Multiple air modulation transducers, can be abutted to respective labyrinth transmission lines. Each of the labyrinth transmission lines act as passive vibrational radiators, to transmit the low frequency air pressure waves into the adjacent lower drying chamber. With two or more sub-sonic frequencies generated by the air modulation transducers, further directed through the passive vibrational radiators into the lower drying chamber, the various sub-sonic frequencies can be purposefully synchronized out of phase and/or off-pitch relative to one another, creating additive ultra-low harmonic “beat” pattern wave forms, generated by the combined effects of the various air modulation transducers.

B4. Shaftless Discharge Screw with Mesh Core

The shaftless discharge screw 240, preferably with an approximately fifteen HP motor, is situated directly underneath the lower drying chamber 210, and preferably all four modules 204 of the unit 205, to receive the dried product 14 material falling down from the two-inch wide channels, above. A typical preferred production rate through the lower drying chamber 210 is ten tons per hour. The shaftless screw is equipped with a mesh screw core 243, within the screw, where the shaft would normally reside.

The mesh screw core 243 of the shaftless discharge screw 240 is preferably a fifty standard mesh cylindrical screen, which is designed remove the final desired percentages of moisture 221 from the dried product 14, by way of indirect vacuum drying. The vacuum is pulled within the core of the screw, and the moisture is drawn through by the discharge screw's own independent, second vacuum fan 252. A wet and nearly saturated second discharge airstream 256′ is preferably exhausted to atmosphere, and the dried product 14 drops into the dried product auger screw 260. The shaftless discharge screw has a preferred footprint of twenty-eight feet long by three feet wide. The preferred horizontal feeder is approximately eighteen inches in diameter, with a six inch and twelve inch pitch, and a twelve inch diameter core, as preferably manufactured by Austin Mac.

### B5. Vacuum Fans

Preferably, for each drying chamber unit 205, two vacuum fans 250, each approximately fifty HP, are utilized to pull negative pressure of ten inches of water column (gage) through the lower drying chamber 210, for the purpose of pulling the moisture 221 laden feedstock 8. The wet, filtered air exhausted by the vacuum fans may be discharged into atmosphere, as is preferred. Most preferably, the air supply end is pulsed to enhance moisture removal. The first vacuum fan 251, pulls air horizontally along the dryer-slots 202 or gaps between the module's channel membranes 220, while the other of the two vacuum fans pulls air horizontally through the twelve inch diameter mesh screw core 243, which is a tube within the approximately twenty-eight foot long shaftless screw 240 These vacuum fans draw the moisture through the mesh material without entraining any of the solids from the feedstock.

The vacuum fans 250 perform the “pull side” function of the push and pull strategy for the AMND system 7, with the process air fan 190 in the upper drying chamber 200 performing the “push side” function. The vacuum fans must be selected to handle the rigors of discharging moist air. The change in vapor pressure from a positive to a negative environment is imperative in this non-thermal drying system. An additional cycling or “pulsing” vacuum air exhaust device may also be utilized in addition to the vacuum fans, the selection of which is known to those skilled in negative air system design. Such a pulsing device may rely on pulsing the vacuum fan motor, introducing a barometric relief damper, or adding an additional vacuum fan to supplement the preferred two vacuum fan configuration in each lower drying chamber 210.

### B6. Dried Product Screw Conveyor

A dried product screw conveyor 260, delivers the dried product, as discharged from the shaftless screw, sideways into the backmix hopper. The dried product screw conveyor is preferably equipped with an approximately five HP motor, and the trough of the screw conveyor preferably includes a hood to capture fugitive dust and any airborne particles that may escape from the lower drying chamber 210. The screw conveyor is situated directly under the discharge of the shaftless screw. This screw preferably sets at an approximate thirty degree incline, and is twelve inches in diameter, with a six inch and twelve inch pitch, and is twenty feet long, with Austin Mac, again a preferred manufacturer.

### B7. Finished Product Outfeed Conveyor

A finished product outfeed conveyor 270 is a preferred, but optional overhead screw conveyor as commercially available from Austin Mac. The outfeed conveyor can be employed to deliver the dried product 14, approximately sixty feet horizontally, into either the backmix hopper, or the finished product trailer, as desired. A preferred screw conveyor is equipped with a fifteen HP motor and five discharge ports. Four discharge ports are air actuated slide gates for level and selective discharge into the backmix hopper or the receiving truck bed. Most preferably, the final discharge port always remains open. The backmix material is initially deposited into the backmix hopper maintaining a ten ton inventory by way of two initial discharge gates.

As is preferred, any dried product 14 in overage is sent on into the finished product trailer or hopper 280, and deposited by the directing action of the three discharge gates of the finished product outfeed conveyor 270. This horizontal conveyor screw is preferably sixty feet in length, and approximately twelve inches in diameter with a twelve inch pitch. If this preferred product conveying strategy is utilized, then a bucket elevator is needed to raise the dried product vertically, approximately twenty feet. Again, alternative handling and conveying methods must be based on the particular feedstock 8 utilized, its desired use, whether as a fuel or a fertilizer, for instance, and site specific parameters, and additional requirements based on recycling and backmixing strategies.

### B8. Outgoing Finished Product Trailer or Hopper

A typical finished product trailer will haul approximately twenty-five tons of dried product. A design fill rate of the dried product biomass is approximately two tons per hour, so the typical twenty-four ton trailer needs to be exchanged every twelve hours. Trailer is backed in and is situated under the three discharge gates of the overhead dried product outfeed conveyor 270. The trailer is tarped after a full load is leveled. Austin Mac is again a preferred manufacturer of the conveyor. Optionally, the dried product may be pelletized, compressed into briquettes, or placed into a surge hopper in its powdered form.

### B9. Motor Control Center (MCC)

Most preferably, all process motors utilize variable speed controllers. A Motor Control Center or “MCC,” which is preferably enclosed in a trailer or other appropriate enclosure, to house the PLC, instrumentation, and diagnostics that comprise the MCC. Rockwell-Allen Bradley or equivalently manufactured system, as designed by a person skilled in process control system technologies can be utilized. A standard moisture analyzer is preferably situated at the incoming wet wood or sludge, and the discharge of final dried product coming out of the drying chamber. Since the total power consumption by the AMND system 7 is relatively low, as compared to convention thermal drying systems, solar power could be utilized to electrify all system motors. The AMND system is designed to be operated by as few as two personnel per shift, with one person at the MCC, and one additional person probably required for maintenance and housekeeping.

### C0. Conclusion

With the above described modular process features and high velocity pneumatics, the AMND system 7 is able to liberate up to ninety percent of the moisture or water content and the reduction of particle size of input materials. The process of the AMND system 7 combines high volumes of process air 191, with infeed motive air 133 that delivers the pre mixed wet feedstock 8 material into the drying chamber 200, which provides for a “mechanical separation” of the moisture 221 from the feedstock. This mechanical separation includes an acoustic induced air motion liberation or “SONICATION™” of the moisture by use of the above described combination of drivers, labyrinth transmission lines, and mechanical air modulating devices. This combination of technologies and equipment make the subject system novel, unique, and effective.

With the AMND system 7, significant reductions in emissions, dust, and odors through the “indirect” drying is provided, as compared to conventional drying systems. As discussed above, the system expelled, airborne moisture may be discharged to atmosphere, without further, expensive processing, or it may be recaptured for potable uses. Intelligent use of vacuum, pressure drop, temperature, air volume, particle size, and vibration are vital, and synergistically contribute to the overall success of the mechanical separation provided by the AMND system.

In compliance with the statutes, the present invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and a constructive reduction to practice, such that a person skilled in the pertinent art or area of technology can read the above expression of the invention and understand its structure and operation. However, the above disclosure is not intended to limit the invention to the particular embodiments described. Those with ordinary skill in the art will appreciate that other embodiments and variations of the invention are possible, which employ the same inventive concepts as described above. Therefore, the invention is not to be limited, except by the following provisional claims, as appropriately interpreted in accordance with patent law and the doctrine of equivalents.

The following is claimed:

1. A dryer system comprising:
a drying chamber, the drying chamber having a membrane channel within a dryer slot;
a wet feedstock received into the dryer slot from a feedstock infeed;
a passive vibrational radiator adjacent to the drying chamber;
a transducer abutted to the passive radiator;
a substantially sub-sonic frequency generated by the transducer and directed through the passive vibrational radiator into the drying chamber;
a moisture stream liberated from the wet feedstock by action of the substantially sub-sonic vibrational frequency, and the moisture stream expelled into the membrane channel from the dryer slot;
an exhaust airstream drawn from the dryer slot by a vacuum fan, the exhaust airstream stream including the moisture stream from the wet feedstock; and
a dried product discharged from the dryer slot of the drying chamber.

2. The dryer system of claim 1, in which the membrane channel has a plurality of channeled membranes.

3. The dryer system of claim 1, in which the dryer slot has a plurality of slots.

4. The dryer system of claim 1, in which the passive radiator is a labyrinth of vibrational transmission lines.

5. The dryer system of claim 1, in which the substantially subsonic frequency is in the range of approximately five kilohertz to approximately twenty kilohertz.

6. The dryer system of claim 1, further comprising:
a second transducer abutted to a second passive vibrational radiator, the second passive vibrational radiator adjacent to the drying chamber;
a second sub-sonic frequency generated by the second transducer and directed through the second passive vibrational radiator into the drying chamber; and
the second sub-sonic frequency is off-pitch relative to the first sub-sonic frequency.

7. The dryer system of claim 6, in which the second subsonic frequency is in the range of approximately five kilohertz to approximately twenty kilohertz.

8. The dryer system of claim 1, in which the feedstock infeed includes an injector nozzle, and the injector nozzle injects the wet feedstock into the dryer slot.

9. The dryer system of claim 1, in which a product discharge conveyor receives the dried product from the dryer slot, and a second vacuum fan draws a second exhaust airstream from the product discharge conveyor, the exhaust stream including a second moisture stream of a residual moisture.

10. A dryer system comprising:
an upper drying chamber connected to a lower drying chamber, the upper drying chamber having a process air supply;
a plurality of membranes within the within the lower drying chamber, the plurality of membranes surrounded by a plurality of dryer slots;
a wet feedstock injected into the upper drying chamber from a feedstock infeed, and the wet feedstock received into the plurality of dryer slots;
a passive vibrational radiator adjacent to the lower drying chamber;
a transducer abutted to the passive vibrational radiator;
a sub-sonic frequency generated by the transducer and directed through the passive radiator into the lower drying chamber;
a moisture stream liberated from the wet feedstock by action of the sub-sonic frequency, and the moisture stream expelled into the membrane channel from the dryer slot;
an exhaust airstream drawn from the dryer slot by a vacuum fan, the exhaust stream including the moisture stream from the wet feedstock; and
a dried product discharged from the dryer slot of the drying chamber.

11. The dryer system of claim 10, in which the feedstock infeed includes an injector nozzle, and the injector nozzle injects the wet feedstock into the dryer slot.

12. The dryer system of claim 10, in which a product discharge conveyor receives the dried product from the dryer slot, and a second vacuum fan draws a second exhaust airstream from the product discharge conveyor, the exhaust stream including a second moisture stream of a residual moisture.

13. The dryer system of claim 10, in which the passive radiator is a labyrinth of vibrational transmission lines.

14. The dryer system of claim 10, in which the substantially subsonic frequency is in the range of approximately five kilohertz to approximately twenty kilohertz.

15. The dryer system of claim 10, further comprising:
a second transducer abutted to a second passive radiator, the second passive radiator adjacent to the drying chamber;
a second sub-sonic frequency generated by the second transducer and directed through the second passive vibrational radiator into the drying chamber; and
the second sub-sonic frequency is off-pitch relative to the first sub-sonic frequency.

16. The dryer system of claim 15, in which the second subsonic frequency is in the range of approximately five kilohertz to approximately twenty kilohertz.

17. A dryer system method comprising the steps of:
a) feeding a wet feedstock into a dryer slot within a drying chamber, the drying chamber also including a membrane channel;
b) generating a sub-sonic frequency with a transducer;
c) transmitting the sub-sonic frequency through a passive vibrational radiator into the drying chamber;
d) liberating a moisture stream from the wet feedstock with the sub-sonic frequency;
e) wicking the moisture stream through a membrane wall of the membrane channel and into the membrane channel;
f) drawing an exhaust airstream from the membrane channel with a vacuum fan, the exhaust stream including the moisture stream from the wet feedstock; and
g) discharging a dried product from the dryer slot of the drying chamber.

18. The dryer system method of claim 17, further including the step of:
h) drawing a second exhaust airstream from the dried product discharged from the dryer slot of the drying chamber with a second vacuum fan.

19. The dryer system method of claim 18, further including the steps of:
h) supplying the wet feedstock to the dryer chamber under a positive pressure relative to atmosphere; and
i) atomizing the wet feedstock into the dryer slot of the drying chamber.
